(19) United States
(12) Patent Application Publication
(10) Pub. No.: US 2026/0261228 A1
(43) Pub. Date: Sep. 3, 2026

(54) Solar Panel Mounting System

(71) Applicant: Energy Transition Design LLC, Brooklyn, NY (US)

(72) Inventor: Alexander Philip Nathanson, Brooklyn, NY (US)

(73) Assignee: Energy Transition Design LLC, Brooklyn, NY (US)

(21) Appl. No.: 19/377,822

(22) Filed: Nov. 3, 2025

Related U.S. Application Data
(60) Provisional application No. 63/765,167, filed on Feb. 28, 2025.

(51) Int. Cl. H02S 20/22; H02G 15/013

(52) U.S. Cl. CPC H02S 20/22; H02G 15/013

(57) ABSTRACT

Among other things, the present disclosure provides an adjustable solar panel mounting system comprising a telescoping frame structure configured to fit within side channels of a double-hung window. The telescoping frame structure comprises a first tube having a first diameter and a second tube having a second diameter smaller than the first diameter, wherein the second tube is configured to telescope within the first tube to provide width adjustability. The adjustable solar panel mounting system comprises a locking connector configured to secure the first tube and second tube in a telescoping position. The adjustable solar panel mounting system comprises a mounting bracket attached to the telescoping frame structure and configured to support a solar panel. The adjustable solar panel mounting system comprises a support leg connected to the mounting bracket and configured to position the solar panel at an adjustable angle relative to the window.

### CROSS-REFERENCE TO RELATED APPLICATIONS

This application claims priority to U.S. Application No. 69/389,755, titled Adjustable solar panel mounting system for window exterior, filed February 28, 2025, which is hereby incorporated by reference in its entirety.

### FIELD OF INVENTION

The present disclosure relates to solar panel mounting systems, and more particularly to an adjustable solar panel mounting system designed for installation on the exterior of double-hung windows without permanent attachment to the building structure.

### BACKGROUND

Solar energy systems have become increasingly popular as individuals and organizations seek to reduce their environmental impact and energy costs. However, the installation of solar panels has traditionally been limited to property owners who have access to suitable roof space and the financial resources to invest in permanent installations.

Renters and residents of multifamily buildings face particular challenges in accessing solar energy technology. These individuals often lack the authority to make permanent modifications to building structures, which conventional solar panel mounting systems typically require. Traditional mounting systems involve drilling, bolting, or otherwise permanently attaching hardware to roofs, walls, or other building surfaces.

Existing solar panel mounting solutions generally fall into two categories: permanent exterior installations and small-scale interior installations. Permanent exterior installations provide optimal sun exposure but require structural modifications that may violate lease agreements or building regulations. Interior installations, while avoiding structural modifications, suffer from reduced light exposure due to window glass interference and are typically limited to very small panel sizes.

The installation of conventional solar mounting systems often requires professional expertise, specialized tools, and permits, creating additional barriers to adoption. These requirements increase both the cost and complexity of solar installations, making them less accessible to individuals with limited resources or temporary housing situations.

Window-mounted installations present particular technical challenges. Double-hung windows have specific structural characteristics, including side channels and varying dimensions, that make adaptation of general-purpose mounting systems difficult. Additionally, running electrical cables from exterior-mounted panels to interior electrical loads while maintaining weather resistance poses engineering challenges.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an adjustable solar panel mounting system is provided. The adjustable solar panel mounting system comprises a telescoping frame structure configured to fit within side channels of a double-hung window. The telescoping frame structure comprises a first tube having a first diameter and a second tube having a second diameter smaller than the first diameter. The second tube is configured to telescope within the first tube to provide width adjustability. The adjustable solar panel mounting system comprises a locking connector configured to secure the first tube and second tube in a telescoping position. The adjustable solar panel mounting system comprises a mounting bracket attached to the telescoping frame structure and configured to support a solar panel. The adjustable solar panel mounting system comprises a support leg connected to the mounting bracket and configured to position the solar panel at an adjustable angle relative to the window.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIGS. 1-2 illustrate different views of an adjustable solar panel mounting system.

FIGS. 3-4 illustrate views of the adjustable solar panel mounting system with a solar panel installed.

FIGS. 5A-5D illustrate sequential views of a cable entry system installation process.

FIG. 6 illustrates an exploded view of the adjustable solar panel mounting system,.

FIGS. 7-9 illustrates a perspective views of the adjustable solar panel mounting system in an installed configuration.

FIGS. 10-11 illustrate a foam strip and foam plug used with the adjustable solar panel mounting system.

### DETAILED DESCRIPTION

Solar panel installations have traditionally presented challenges for renters and residents of multifamily buildings who lack permission, access, or resources to implement conventional mounting systems. Existing solar panel mounting methods typically require permanent attachment to building structures through drilling, screwing, or other invasive installation techniques that may violate lease agreements or building regulations. These conventional systems often demand professional installation services and specialized tools, creating cost barriers and accessibility limitations that prevent many individuals from participating in renewable energy adoption.

The present disclosure addresses these limitations by providing an adjustable solar panel mounting system specifically designed for installation on double-hung windows. The system enables users to mount solar panels on the exterior of windows without making permanent modifications to building structures. In some cases, the mounting system may be installed and removed without leaving permanent marks or damage, making the system suitable for rental properties and situations where building modifications are restricted or prohibited.

The mounting system provides adjustability to accommodate various window dimensions commonly found in double-hung window installations. In some cases, the system may be configured for installation by users without specialized tools or professional assistance, reducing installation costs and complexity. The system may allow solar panels to be positioned on the exterior of windows where solar exposure may be maximized compared to interior mounting solutions.

The mounting system may include weatherproofing features that allow electrical cables to pass from exterior-mounted solar panels to interior electrical systems while maintaining weather resistance. In some cases, the system may be designed for easy removal and reinstallation, allowing users to relocate the mounting system when moving to different residences. The system provides structural stability and adjustable positioning for solar panels while maintaining compatibility with standard double-hung window configurations.

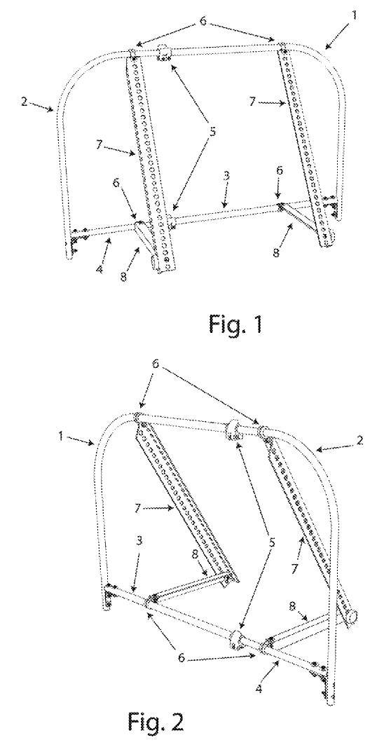

Referring to FIGS. 1 and 2, the adjustable solar panel mounting system includes a frame structure configured to fit within the side channels of double-hung windows. The mounting system comprises a large diameter tube 1 and a small diameter tube 2 that form vertical frame members of the mounting assembly. In some cases, the small diameter tube 2 is configured to telescope within the large diameter tube 1 to provide adjustability for different window widths.

The mounting system further includes a straight large tube 3 and a straight small tube 4 that form horizontal frame members. In some cases, the straight small tube 4 is configured to telescope within the straight large tube 3, providing additional adjustability for the frame dimensions. The telescoping configuration of these tube components enables the mounting system to accommodate various window sizes without requiring permanent modifications to the window structure.

With continued reference to FIGS. 1 and 2, the mounting system includes a locking connector 5 configured to secure the telescoping tubes in desired positions. In some cases, the locking connector 5 is positioned to maintain the extended or contracted configuration of the tube assemblies during installation and operation. The locking connector 5 provides a mechanism for users to adjust and secure the frame dimensions without requiring additional tools.

The mounting system includes multiple mounting clamps 6 positioned at various connection points along the frame structure. In some cases, the mounting clamps 6 are configured to secure different components of the mounting system together. The mounting clamps 6 provide removable connections that allow for assembly and disassembly of the mounting system components.

As shown in FIGS. 1 and 2, the mounting system includes angled brackets 7 that extend from the frame structure. The angled brackets 7 may be configured to support and position a solar panel at a desired angle relative to the window opening. In some cases, the angled brackets 7 provide mounting points for attaching solar panel hardware to the frame assembly.

The mounting system further includes support legs 8 that provide structural stability and positioning for the solar panel installation. In some cases, the support legs 8 are connected to the angled brackets 7 to form a stable support structure. The support legs 8 are adjustable to accommodate different solar panel angles and installation configurations.

The combination of the large diameter tube 1, small diameter tube 2, straight large tube 3, and straight small tube 4 form a frame structure when assembled. In some cases, the configuration may provide structural stability while allowing the frame to fit securely within the vertical side channels of double-hung windows. The frame structure may be configured to press against the interior surfaces of the window channels to maintain position without requiring permanent attachment hardware. In some examples, the frame structure is A-shaped, but the frame structure can take other forms as well.

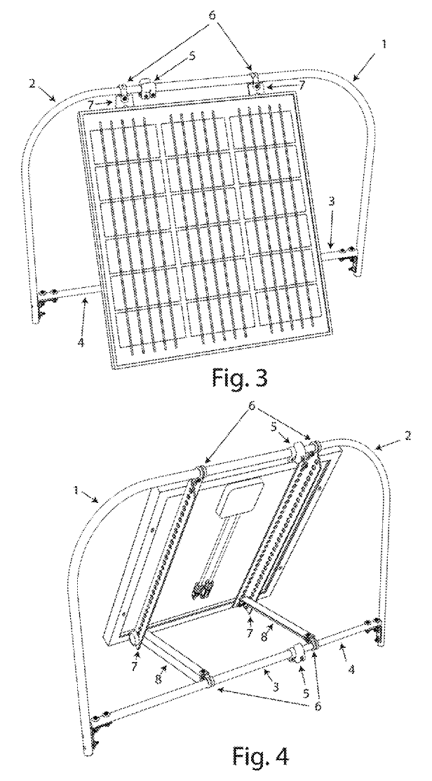

Referring to FIGS. 3 and 4, the mounting system may be configured to support a solar panel in an installed configuration. FIG. 3 shows a front view of the mounting system with a solar panel installed, while FIG. 4 is a rear view. The frame structure comprising the large diameter tube 1, small diameter tube 2, straight large tube 3, and straight small tube 4 provides a stable foundation for solar panel positioning.

The mounting system may include an angled bracket 7 configured to provide mounting points for solar panel attachment. In some cases, the angled bracket 7 may be dimensioned to approximately 30 inches in length, with the specific length depending on the dimensions of the solar panel intended for installation. The angled bracket 7 may include mounting holes distributed throughout the entire length of the bracket to enable adjustment of solar panel positioning and angle.

With continued reference to FIGS. 3 and 4, the mounting system may include a support leg 8 that provides structural support and angular positioning for the solar panel installation. In some cases, the support leg 8 may be dimensioned within a range of 12 to 18 inches in length, with the specific length selected based on the desired tilt angle for the solar panel. The support leg 8 may be connected to the angled bracket 7 to form a stable triangular support structure that maintains the solar panel at the desired angle.

The connection between the angled bracket 7 and the support leg 8 may be accomplished using thumb screws and wing nuts. In some cases, this connection method may minimize the tool requirements during installation and assembly of the mounting system. The thumb screws and wing nuts may allow users to adjust and secure the connection between the angled bracket 7 and the support leg 8 without requiring specialized tools or equipment.

As shown in FIGS. 3 and 4, a mounting clamp 6 may be configured to secure the angled bracket 7 to the frame structure. In some cases, multiple mounting clamps 6 may be positioned to attach the angled bracket 7 to the large diameter tube 1 and small diameter tube 2. Additional mounting clamps 6 may secure the support leg 8 to the straight large tube 3 and straight small tube 4, providing stable attachment points throughout the frame assembly.

The mounting holes distributed along the length of the angled bracket 7 may enable users to adjust the solar panel angle to accommodate various installation conditions. In some cases, the angle adjustment capability is used to mitigate sun obstructions that may affect solar panel performance. The adjustable positioning may also accommodate variations in facade depth where the window installation is recessed or protruding from the building surface.

The angular adjustment provided by the mounting holes in the angled bracket 7 may allow users to optimize solar panel positioning for seasonal variations in sun angle. In some cases, the adjustment capability may enable users to account for their specific latitude location to maximize solar energy collection throughout the year. The combination of the angled bracket 7 and support leg 8 may provide a stable and adjustable platform for solar panel installation while maintaining compatibility with the telescoping frame structure.

In some implementations, the telescoping frame structure has a configurable height using a similar combination of telescoping tubes as described above.

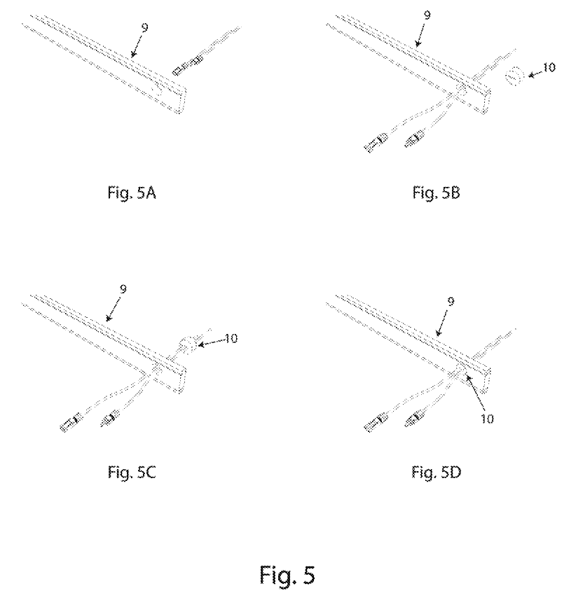

Referring to FIGS. 5A-5D, the mounting system may include a weatherproof cable entry system configured to allow electrical cables from the solar panel to pass into the interior of the building while maintaining weather resistance. The cable entry system may comprise a foam strip 9 and a foam plug 10 that work together to create a weather-tight seal around electrical cables passing through the window interface.

As shown in FIG. 5A, a foam strip 9 may be positioned along the bottom edge of the window opening where the mounting system interfaces with the window frame. In some cases, the foam strip 9 may have cross-sectional dimensions of approximately 1 inch wide by 3 inches tall. The foam strip 9 may include an adhesive surface on the bottom portion configured to adhere to the window frame during installation. In some implementations, the foam strip 9 is comprised of multiple types of materials. For example, the foam strip 9 may include three layers, e.g., a firmer foam material sandwiched between two less firm foam materials.

The foam strip 9 may include a hole positioned approximately 3 inches from one end of the strip. In some cases, the hole may have a diameter of approximately 1.5 inches, which may be sized to allow electrical cables with bulky connector heads to pass through the opening. The hole dimensions may accommodate standard solar panel electrical connectors and cable assemblies commonly used in solar panel installations.

With continued reference to FIGS. 5A-5D, the cable entry system may include a foam plug 10 configured to seal the hole in the foam strip 9 after cables have been passed through the opening. In some cases, the foam plug 10 may be sized to approximately 1.3 times the diameter of the hole in the foam strip 9 to provide proper compression and sealing when inserted into the opening.

As shown in FIG. 5B, the foam plug 10 may include two holes, each approximately one-quarter inch in diameter, drilled through the plug material. The foam plug 10 may further include a horizontal cut extending from one hole, through the other hole, to one edge of the plug. In some cases, this perforation design may allow the foam plug 10 to be slid onto electrical cables from the side rather than requiring the cables to be threaded through the plug.

The sequential installation process may be demonstrated in FIGS. 5C and 5D. As shown in FIG. 5C, the foam plug 10 may be positioned partially within the hole of the foam strip 9 after being slid onto the electrical cables. FIG. 5D may show the foam plug 10 fully inserted into the hole in the foam strip 9, creating a weather-resistant seal around the electrical cables.

The horizontal cut in the foam plug 10 may enable installation of the plug onto cables that already have connectors or other components attached to the cable ends. In some cases, the side-loading capability provided by the perforation design may eliminate the need to disconnect or remove cable connectors during installation of the weatherproofing system. The foam plug 10 may compress within the hole of the foam strip 9 to form a tight seal that prevents water infiltration while allowing electrical cables to pass through the interface.

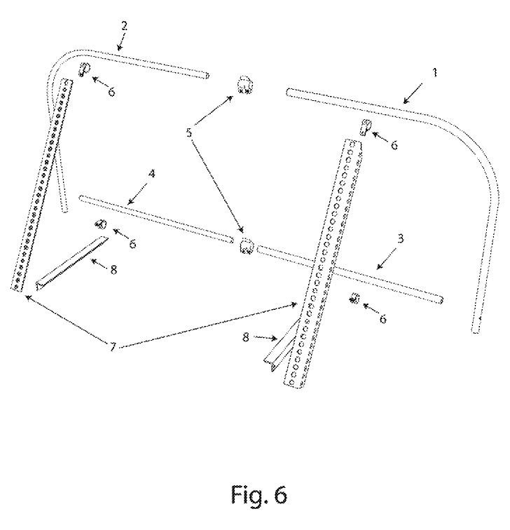

Referring to FIG. 6, the mounting system may be shown in an exploded view that demonstrates the telescoping frame construction and the relationship between the various frame components. The exploded configuration illustrates how the small diameter tube 2 may be configured to fit within the large diameter tube 1, and how the straight small tube 4 may be configured to fit within the straight large tube 3 to provide the adjustable telescoping functionality.

The large diameter tube 1 may be dimensioned with a diameter of approximately three-quarters of an inch. In some cases, this diameter may be sized to fit within the side channels of double-hung windows in a manner that minimizes excessive movement or "wiggle room" while still allowing for proper installation and positioning. The large diameter tube 1 may be configured in a 90-degree bent configuration that provides the angled portion of the frame structure. In some implementations, rather than a large diameter tube configured in a 90-degree bent configuration, two tubes joined at a 90 degree angle could be used.

The small diameter tube 2 may be dimensioned with a diameter of, e.g., approximately five-eighths of an inch. In some cases, the diameter of the small diameter tube 2 is sized to fit within the interior of the large diameter tube 1 while allowing for smooth telescoping movement during adjustment operations. The dimensional relationship between the large diameter tube 1 and the small diameter tube 2 enables the telescoping capability that in turn enables width adjustment of the mounting system.

With continued reference to FIG. 6, the large diameter tube 1 and small diameter tube 2 may have a length of approximately 44 inches in the 90-degree bent configuration. The straight large tube 3 and the straight small tube 4 may each be dimensioned to approximately 22 inches in length. In some cases, the straight tube sections may be cut to roughly half the length of the 90-degree bent tube sections to provide appropriate proportions for the frame assembly.

The 90-degree angled configuration of the large diameter tube 1 and the small diameter tube 2 may be formed using a pipe bender manufacturing method. In some cases, the pipe bender may create the 90-degree bend while maintaining the structural integrity and dimensional consistency of the tube materials. The bending process may produce the angled frame members that form the upper portion of the A-shaped frame structure.

As shown in FIG. 6, the large diameter tube 1 may include counter sunk holes positioned at specific locations along the tube length. In some cases, the counter sunk holes may be configured to prevent bolts or fasteners from protruding beyond the surface of the tube and potentially contacting the window frame during installation. The counter sunk design may allow bolts to sit flush with or below the tube surface, reducing interference with the window channel surfaces.

The mounting clamp 6 may be configured with an interior diameter that matches the exterior diameter of the large diameter tube 1. In some cases, this dimensional matching may provide a snug attachment when the mounting clamp 6 is positioned on the large diameter tube 1 or the straight large tube 3. When the mounting clamp 6 is positioned on the small diameter tube 2 or the straight small tube 4, the mounting clamp 6 may remain loose due to the smaller exterior diameter of these components.

The loose fit between the mounting clamp 6 and the smaller diameter tubes enables easy adjustment of the telescoping frame components. In some cases, the loose connection may allow one side of the frame assembly to move freely during adjustment operations while the other side remains securely clamped in position. This configuration facilitates the telescoping adjustment process by allowing users to extend or contract the frame width while maintaining secure connections at the appropriate attachment points.

The locking connector 5 may be configured to secure the telescoping tubes in their adjusted positions once the desired frame width has been achieved. In some cases, the locking connector 5 may provide a mechanism for maintaining the extended or contracted configuration of the tube assemblies during installation and operation of the mounting system. The locking connector 5 may enable users to quickly secure the telescoping adjustment without requiring additional tools or complex fastening procedures.

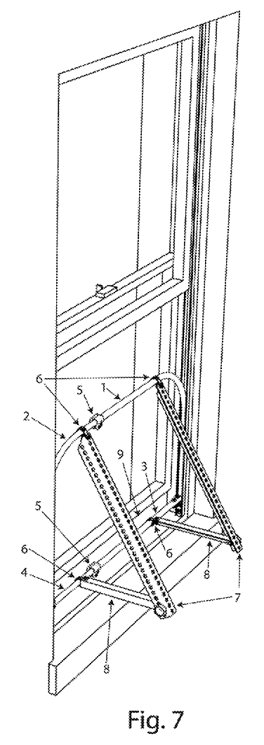

Referring to FIG. 7, the mounting system is shown in a fully assembled and installed configuration that demonstrates the integration of the telescoping frame structure, mounting hardware, and cable entry system as a complete operational unit and installed in a window. The assembled system illustrates how the large diameter tube 1, small diameter tube 2, straight large tube 3, and straight small tube 4 combine to form the complete A-shaped frame structure that provides the foundation for solar panel mounting in double-hung window installations.

The fully assembled frame structure includes the telescoping relationship between the tube components, where the small diameter tube 2 may be positioned within the large diameter tube 1, and the straight small tube 4 may be positioned within the straight large tube 3. In some cases, the telescoping configuration may allow the frame width to be adjusted to accommodate various window dimensions while maintaining structural integrity throughout the adjustment range.

With continued reference to FIG. 7, the locking connector 5 may be positioned to secure the telescoping tubes in their extended configuration for installation in a window opening. The locking connector 5 maintains the frame dimensions during installation and operation, preventing unwanted movement or collapse of the telescoping structure. In some cases, the locking connector 5 enables users to quickly secure the frame in the desired width configuration without requiring additional tools or fastening hardware.

The mounting clamps 6 may be positioned at various connection points throughout the assembled frame structure to secure the angled bracket 7 and support leg 8 to the frame assembly. In some cases, the mounting clamps 6 provide the connection interface between the frame tubes and the solar panel mounting hardware. The angled bracket 7 may be secured to the upper portion of the frame structure, while the support leg 8 may be attached to the lower frame components to create the triangular support structure for solar panel positioning.

As shown in FIG. 7, the foam strip 9 may be positioned along the bottom edge of the frame assembly where the mounting system interfaces with the window opening. The foam strip 9 may be configured to create a weather barrier when the window sash closes down onto the foam material. In some cases, the foam strip 9 compresses under the weight and pressure of the window sash to form a seal that prevents air infiltration and water penetration at the window interface.

The installation process may involve positioning the assembled frame structure within the window opening with the frame in a contracted configuration. In some cases, the frame is sized to fit through the window opening when the telescoping tubes are in their most compressed position. Once positioned within the window opening, the frame may be expanded by extending the telescoping tube assemblies until the frame components press against the interior surfaces of the vertical side channels of the double-hung window.

The frame expansion process creates a friction fit between the frame structure and the window channels that secures the mounting system in position without requiring permanent attachment hardware. In some cases, the dimensional sizing of the large diameter tube 1 and straight large tube 3 may be configured to fit snugly within the window side channels, providing stable positioning while allowing for removal when desired.

With continued reference to FIG. 7, the foam strip 9 may be positioned to rest on the window sill or lower frame member when the mounting system is installed. The window sash may be lowered to close down onto the foam strip 9, creating compression that forms a weather-resistant seal around the perimeter of the mounting system installation. In some cases, the foam strip 9 may deform under the closing pressure of the window sash to fill gaps and irregularities in the window frame surfaces.

The weather barrier created by the foam strip 9 may prevent outdoor air, moisture, and precipitation from entering the interior space through the window opening where the mounting system is installed. In some cases, the foam strip 9 may maintain the weather seal while allowing the mounting system to remain removable for relocation or storage purposes. The adhesive surface on the bottom of the foam strip 9 may provide additional sealing capability by adhering to the window frame surfaces during installation.

The complete assembled system may provide a stable and adjustable platform for solar panel installation that accommodates various window dimensions without requiring permanent modifications to the building structure. In some cases, the integrated design of the telescoping frame, mounting hardware, and weather sealing components may enable users to install and operate solar panels in rental properties or other situations where permanent building modifications are prohibited or undesirable.

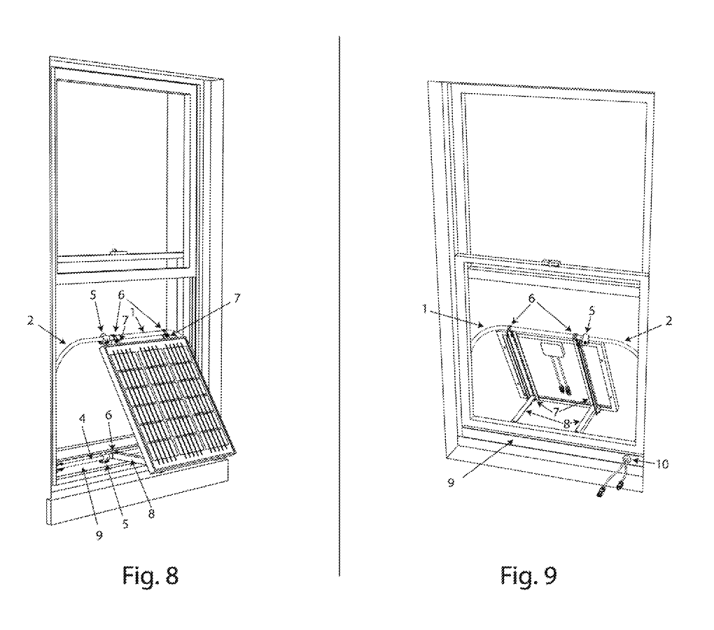

Referring to FIGS. 8 and 9, the mounting system is shown in orthogonal views that illustrate the spatial relationships between components during operational configuration. The orthogonal perspectives demonstrate how the various system components interact to provide secure mounting functionality while maintaining the adjustability and weather resistance features of the mounting system.

As shown in FIGS. 8 and 9, the small diameter tube 2 may be positioned within the telescoping frame structure to provide width adjustability for the mounting system. In some cases, the small diameter tube 2 may be configured to slide within the corresponding large diameter tube to accommodate different window dimensions. The telescoping relationship allows the frame to be contracted for installation through the window opening and then expanded to fit securely within the window side channels.

The straight small tube 4 may be positioned to form the lower horizontal portion of the frame assembly in conjunction with the small diameter tube 2. In some cases, the straight small tube 4 telescopes within the corresponding straight large tube to provide coordinated width adjustment of both the upper and lower portions of the frame structure. The coordinated telescoping action may maintain the structural integrity of the A-shaped frame configuration throughout the adjustment range.

With continued reference to FIGS. 8 and 9, the locking connector 5 may be positioned to secure the telescoping relationship between the tube components once the desired frame width has been achieved. The locking connector 5 maintains the spatial positioning of the small diameter tube 2 and straight small tube 4 relative to their corresponding large diameter tubes during installation and operation. In some cases, the locking connector 5 may prevent unwanted movement or dimensional changes in the frame structure while the mounting system supports the solar panel installation.

The mounting clamp 6 may be configured to provide secure attachment points between the frame structure and the solar panel mounting hardware. In some cases, multiple mounting clamps 6 may be positioned at strategic locations to connect the angled bracket 7 and support leg 8 to the telescoping frame assembly. The mounting clamps 6 may accommodate the dimensional differences between the large diameter tubes and small diameter tubes while providing stable connections throughout the frame structure.

As shown in FIGS. 8 and 9, the angled bracket 7 may be secured to the frame structure through the mounting clamps 6 to provide the primary mounting interface for solar panel attachment. The angled bracket 7 may extend from the frame assembly at a predetermined angle that positions the solar panel for optimal solar exposure. In some cases, the angled bracket 7 may include multiple mounting holes that enable adjustment of the solar panel angle to accommodate various installation conditions and seasonal sun angle variations.

The support leg 8 may be connected to the angled bracket 7 to form a triangular support structure that maintains the solar panel at the desired angle relative to the window opening. In some cases, the support leg 8 may be attached to the lower portion of the frame structure through mounting clamps 6 to provide stable anchoring for the solar panel support system. The connection between the angled bracket 7 and support leg 8 may create a rigid triangular geometry that resists deflection under wind loads and other environmental forces.

With continued reference to FIGS. 8 and 9, the foam strip 9 may be positioned along the bottom edge of the mounting system to interface with the window frame and sash during installation. The foam strip 9 may be configured to compress when the window sash is lowered, creating a weather-resistant seal around the perimeter of the mounting system installation. In some cases, the foam strip 9 may deform to conform to irregularities in the window frame surfaces while maintaining continuous contact that prevents air and water infiltration.

The foam plug 10 may be positioned within the foam strip 9 to provide a weather-resistant passage for electrical cables from the solar panel to the interior electrical system. In some cases, the foam plug 10 may be compressed within the hole in the foam strip 9 to form a tight seal around the electrical cables while allowing the cables to pass through the weather barrier. The foam plug 10 may accommodate multiple cables while maintaining the weather resistance of the cable entry system.

The spatial relationship between the foam strip 9 and foam plug 10 may create a dual-barrier weather sealing system where the foam strip 9 provides the primary weather seal at the window interface and the foam plug 10 provides localized sealing around the cable penetration. In some cases, the compression of both foam components may work together to prevent water infiltration while maintaining the removable installation characteristics of the mounting system.

The views shown in FIGS. 8 and 9 may demonstrate how the telescoping frame structure maintains structural stability while providing adjustability for various window dimensions. The interaction between the small diameter tube 2, straight small tube 4, and locking connector 5 may enable the frame to be adjusted to fit securely within window side channels of different widths. In some cases, the telescoping capability may allow a single mounting system design to accommodate a range of standard double-hung window sizes without requiring custom sizing or modification.

The mounting hardware comprising the angled bracket 7, support leg 8, and mounting clamps 6 may provide a stable platform for solar panel installation that maintains proper positioning throughout the operational life of the system. In some cases, the triangular support geometry created by the angled bracket 7 and support leg 8 may distribute loads effectively throughout the frame structure, preventing excessive stress concentrations that could compromise the mounting system integrity.

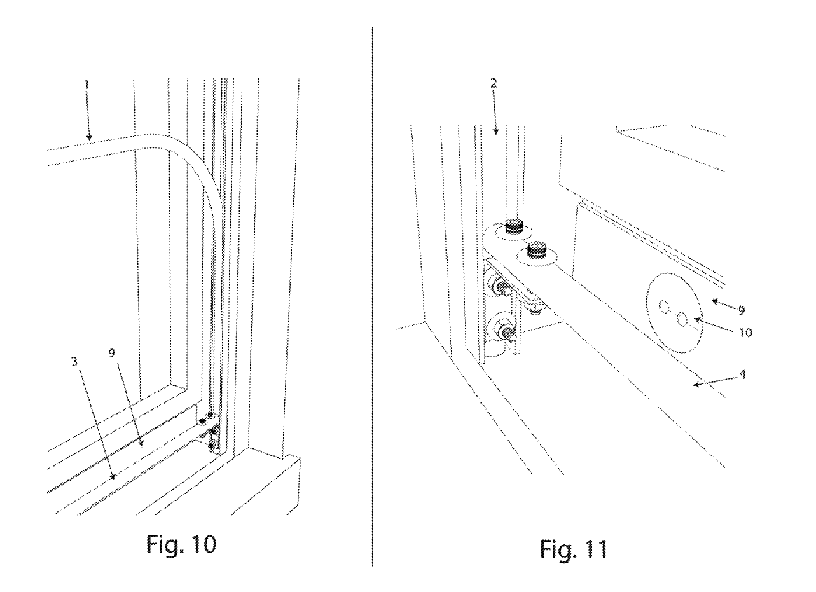

Referring to FIGS. 10 and 11, the mounting system may be shown in orthogonal views that illustrate the frame assembly with the cable management components integrated into the overall system configuration. The views may demonstrate the relationship between the telescoping frame structure and the weatherproofing elements that enable electrical cable passage from exterior solar panels to interior electrical systems.

As shown in FIGS. 10 and 11, the large diameter tube 1 may form the primary structural element of the angled portion of the frame assembly. In some cases, the large diameter tube 1 may be configured in the 90-degree bent configuration that provides the upper angled section of the A-shaped frame structure. The large diameter tube 1 may be dimensioned to fit within the vertical side channels of double-hung windows while providing structural support for the solar panel mounting hardware.

The small diameter tube 2 may be positioned within the large diameter tube 1 to provide the telescoping adjustment capability for the frame width. In some cases, the small diameter tube 2 may slide within the large diameter tube 1 to accommodate various window dimensions during installation. The telescoping relationship between the large diameter tube 1 and small diameter tube 2 may enable the frame to be contracted for passage through the window opening and expanded for secure positioning within the window channels.

With continued reference to FIGS. 10 and 11, the straight large tube 3 may form the horizontal structural element of the lower portion of the frame assembly. The straight large tube 3 may be configured to work in conjunction with the large diameter tube 1 to provide the structural foundation for the mounting system. In some cases, the straight large tube 3 may be dimensioned to match the diameter of the large diameter tube 1 to maintain consistent structural properties throughout the frame assembly.

The straight small tube 4 may be positioned within the straight large tube 3 to provide coordinated telescoping adjustment with the upper portion of the frame structure. In some cases, the straight small tube 4 may telescope within the straight large tube 3 in coordination with the movement of the small diameter tube 2 within the large diameter tube 1. The coordinated telescoping action may maintain the geometric integrity of the A-shaped frame configuration throughout the adjustment range.

As shown in FIGS. 10 and 11, the foam strip 9 may be positioned along the bottom interface of the mounting system where the frame assembly contacts the window frame during installation. The foam strip 9 may be configured to create a weather barrier that prevents air and water infiltration around the perimeter of the mounting system installation. In some cases, the foam strip 9 may compress when the window sash is lowered to form a continuous seal around the mounting system interface.

The foam plug 10 may be positioned within the foam strip 9 to provide a weather-resistant passage for electrical cables from the solar panel installation. In some cases, the foam plug 10 may be configured with the perforation design that allows the plug to be installed onto electrical cables from the side rather than requiring threading of the cables through the plug material. The foam plug 10 may compress within the hole of the foam strip 9 to create a tight seal around the electrical cables while maintaining weather resistance.

The locking connector 5 may be configured to utilize alternative locking mechanisms depending on the specific design requirements and user preferences for the mounting system. In some cases, the locking connector 5 may incorporate lever locks that provide quick-release functionality for rapid adjustment and securing of the telescoping frame components. Lever locks may enable users to operate the locking mechanism with a simple lever motion that engages or disengages the locking function without requiring rotational movement or complex manipulation.

Alternative configurations of the locking connector 5 may utilize twist locks that secure the telescoping tubes through rotational engagement. In some cases, twist locks may provide secure locking through a quarter-turn or half-turn rotation that engages locking elements within the connector mechanism. The twist lock configuration may offer reliable securing capability while maintaining ease of operation for users during frame adjustment procedures.

The locking connector 5 may alternatively incorporate knob locks that provide locking functionality through rotational tightening of a knob mechanism. In some cases, knob locks may enable users to achieve variable locking force by adjusting the degree of knob rotation during the locking process. The knob lock configuration may provide fine adjustment capability for the locking force applied to the telescoping tube components.

The frame components of the mounting system may be constructed from various metal shapes that provide structural strength while maintaining the telescoping functionality and dimensional requirements for window channel installation. In some cases, the large diameter tube 1, small diameter tube 2, straight large tube 3, and straight small tube 4 may be constructed from tubular metal sections that provide hollow cross-sections for reduced weight while maintaining structural integrity.

Alternative configurations may utilize metal channels as the structural shape for the frame components. In some cases, metal channels may provide open cross-sectional geometry that offers structural strength while enabling access to the interior of the frame members for cable routing or other functional requirements. Channel-shaped frame components may be oriented to provide optimal structural properties for the specific loading conditions encountered during solar panel mounting applications.

The frame components may alternatively be constructed from metal angles that provide L-shaped cross-sectional geometry. In some cases, angle-shaped frame members may offer structural efficiency for applications where bending loads are the primary structural concern. The angle configuration may provide directional strength characteristics that may be oriented to resist the specific load patterns generated by solar panel installations and wind loading conditions.

The connection methods used to join the frame components together may vary depending on the manufacturing requirements, structural performance specifications, and assembly preferences for the mounting system. In some cases, welding may be utilized to create permanent connections between frame components where high structural strength and rigid joints are desired. Welded connections may provide continuous load transfer between frame members while eliminating the potential for loosening or separation during operational loading.

Alternative connection methods may utilize bolting to join frame components together with removable fasteners. In some cases, bolted connections may enable disassembly of the frame structure for maintenance, repair, or reconfiguration purposes. Bolted joints may provide high strength connections while maintaining the ability to adjust or replace individual frame components as needed throughout the operational life of the mounting system.

The frame components may be connected using locking mechanisms that provide secure joining without requiring separate fasteners or welding operations. In some cases, locking connections may incorporate integral features within the frame components that engage to create secure joints through mechanical interlocking. Locking connections may enable rapid assembly and disassembly of the frame structure while maintaining structural integrity during operation.

Bending methods may be utilized to create the A-shaped frame configuration by forming continuous frame members into the desired geometric shape. In some cases, bending operations may eliminate the need for separate connection hardware by creating the frame geometry from continuous material sections. The bending approach may provide structural continuity throughout the frame assembly while reducing the number of individual components required for the mounting system construction.

In some regions, like New York City, households with small children are required to have safety bars in the windows. Cross pieces that meet the requirements for safety bars could also be included.

A number of implementations have been described. Nevertheless, it will be understood that various modifications may be made without departing from the spirit and scope of the disclosure. Accordingly, other implementations are within the scope of the following claims.

1. An adjustable solar panel mounting system, comprising:
a telescoping frame structure configured to fit within side channels of a double-hung window, the telescoping frame structure comprising a first tube having a first diameter and a second tube having a second diameter smaller than the first diameter, wherein the second tube is configured to telescope within the first tube to provide width adjustability;
a locking connector configured to secure the first tube and second tube in a telescoping position;
a mounting bracket attached to the telescoping frame structure and configured to support a solar panel; and
a support leg connected to the mounting bracket and configured to position the solar panel at an adjustable angle relative to the window.

2. The adjustable solar panel mounting system of claim 1, wherein the telescoping frame structure further comprises a third tube having the first diameter and a fourth tube having the second diameter, wherein the fourth tube is configured to telescope within the third tube.

3. The adjustable solar panel mounting system of claim 2, wherein the first tube and second tube are configured in a 90-degree bent configuration, and the third tube and fourth tube are configured as straight tubes.

4. The adjustable solar panel mounting system of claim 3, wherein the first tube and third tube have a diameter of approximately three-quarters of an inch, and the second tube and fourth tube have a diameter of approximately five-eighths of an inch.

5. The adjustable solar panel mounting system of claim 1, further comprising a plurality of mounting clamps configured to secure the mounting bracket and support leg to the telescoping frame structure.

6. The adjustable solar panel mounting system of claim 5, wherein each mounting clamp has an interior diameter that matches an exterior diameter of the first tube to provide a snug attachment when positioned on the first tube.

7. The adjustable solar panel mounting system of claim 1, wherein the mounting bracket includes a plurality of mounting holes distributed along a length of the mounting bracket to enable adjustment of a solar panel angle.

8. The adjustable solar panel mounting system of claim 7, wherein the support leg is connected to the mounting bracket using one or more screws.

9. The adjustable solar panel mounting system of claim 1, further comprising a cable entry system comprising a foam strip and a foam plug configured to create a seal around electrical cables passing through a window interface.

10. The adjustable solar panel mounting system of claim 9, wherein the foam strip includes a hole, and the foam plug is sized to approximately 1.3 times a diameter of the hole.

11. The adjustable solar panel mounting system of claim 9, wherein the foam plug includes at least two holes each approximately one-quarter inch in diameter, and a horizontal cut extending from one hole through the other hole to one edge of the foam plug.

12. A method of installing a solar panel mounting system in a double-hung window, comprising:
providing a telescoping frame structure having adjustable width dimensions;
positioning the telescoping frame structure within a window opening in a contracted configuration;
expanding the telescoping frame structure until frame components press against interior surfaces of vertical side channels of the double-hung window;
securing the telescoping frame structure in the expanded configuration using a locking mechanism; and
attaching a solar panel to mounting hardware connected to the telescoping frame structure.

13. The method of claim 12, further comprising a step of positioning a foam strip along a bottom edge of the window opening to create a weather barrier when a window sash closes down onto the foam strip.

14. The method of claim 13, further comprising a step of passing electrical cables from the solar panel through a hole in the foam strip and sealing the hole with a foam plug to create a weather-resistant cable entry.

15. The method of claim 14, wherein the foam plug includes two holes each approximately one-quarter inch in diameter and a horizontal cut extending from one hole through the other hole to one edge of the foam plug, allowing the foam plug to be slid onto the electrical cables from a side.

16. The method of claim 12, further comprising a step of adjusting an angle of the solar panel by connecting the solar panel to an angled mounting bracket having a plurality of mounting holes distributed along a length of the angled mounting bracket.

17. A weatherproof cable entry system for a window-mounted solar panel installation, comprising:
a foam strip configured to be positioned along a bottom edge of a window opening, the foam strip having a hole formed therethrough; and
a foam plug configured to be inserted into the hole of the foam strip, the foam plug having a perforation extending from an interior of the foam plug to an edge of the foam plug, wherein the perforation allows the foam plug to be slid onto electrical cables from a side of the foam plug and the foam plug creates a weather-resistant seal around the electrical cables when inserted into the hole.

18. The weatherproof cable entry system of claim 17, wherein the foam strip has cross-sectional dimensions of approximately 1 inch wide by 3 inches tall.

19. The weatherproof cable entry system of claim 17, wherein the foam strip includes an adhesive surface on a bottom portion configured to adhere to a window frame during installation.

20. The weatherproof cable entry system of claim 17, wherein the perforation comprises two holes each approximately one-quarter inch in diameter and a horizontal cut extending from one hole through the other hole to the edge of the foam plug.
